(19) United States
(12) Patent Application Publication
(10) Pub. No.: US 2026/0035212 A1
(43) Pub. Date: Feb. 5, 2026

(54) ELEVATOR CAR, ELEVATOR SYSTEM AND METHOD OF ACCESSING A SPACE IN A HOISTWAY OF AN ELEVATOR SYSTEM

(71) Applicant: Otis Elevator Company, Farmington, CT (US)

(72) Inventors: Gerard Sirigu, Gien (FR); Pascal Rebillard, Gien (FR)

(21) Appl. No.: 19/280,783

(22) Filed: Jul. 25, 2025

(30) Foreign Application Priority Data
Jul. 31, 2024 (EP) 24306295.7

(51) Int. Cl. B66B 11/02; B66B 5/00; B66B 13/02

(52) U.S. Cl. CPC B66B 11/0246; B66B 5/0087; B66B 13/02

(57) ABSTRACT

An elevator car (6) configured for moving in a hoistway (4) between a plurality of landings (8a-8d). The elevator car includes a floor (6a) provided at a bottom of the elevator car and at least one floor hatch assembly (22) formed in the floor. The at least one floor hatch assembly (22) is movable between a closed configuration and an open configuration. When arranged in the open configuration, the at least one floor hatch assembly (22) provides an opening (60) in the floor (6a) of the elevator car (6) that allows a person (20) to access a space (24) in the hoistway (4) below the elevator car (6) from inside the elevator car (6). When the floor hatch assembly (22) is in the open configuration, the area of the opening (60) provided in the floor (6a) of the elevator car (6) covers an area of at least 0.35 m2.

### FOREIGN PRIORITY

This application claims priority to European Patent Application No. 24306295.7, filed Jul. 31, 2024, and all the benefits accruing therefrom under 35 U.S.C. § 119, the contents of which in its entirety are herein incorporated by reference.

### TECHNICAL FIELD OF INVENTION

The invention relates to an elevator car for an elevator system, wherein the elevator car allows for accessing a space that is located in a hoistway of the elevator system below the elevator car. The invention further relates to an elevator system comprising such an elevator car. The invention also relates to a method of accessing a space that is located in a hoistway of the elevator system below the elevator car.

### BACKGROUND OF THE INVENTION

An elevator system typically comprises at least one elevator car configured for moving along a hoistway extending between a plurality of landings.

For inspection, repair and/or maintenance, a person, in particular a mechanic, may need to enter the hoistway. The person may in particular need to enter a space below the elevator car that is located in a lower portion of the hoistway, in particular a space between the bottom of the elevator car and the bottom of the hoistway.

When a person is in the hoistway, especially below the elevator car, it creates a potentially dangerous situation, in particular when the elevator system has a low pit, in particular with a pit having a height of less than 2 m, as there is a risk that the person is hit or squeezed by the elevator car when the elevator car is moving downwards.

It would therefore be beneficial to provide an improved elevator system with an improved elevator car that allows a person to conveniently access the hoistway, in particular to access a space below the elevator car, wherein the elevator system enhances the safety of the person located in the hoistway, in particular in a portion of the hoistway below the elevator car.

### SUMMARY OF THE INVENTION

According to an exemplary embodiment of the invention, an elevator car that is configured for moving in a hoistway between a plurality of landings comprises a floor hatch assembly formed at a bottom of the elevator car for allowing a person, in particular a mechanic, to access a space located in a portion of the hoistway below the elevator car from inside the elevator car. The floor hatch assembly is movable between a closed configuration and an open configuration. When arranged in the open configuration, the floor hatch assembly provides an opening in the floor of the elevator car that allows a person to access a space in the hoistway below the elevator car from inside the elevator car. When the floor hatch assembly is in the open configuration, the opening provided in the floor of the elevator car provides a safety volume extending into the elevator car, in particular when the elevator car is located adjacent to the bottom of the hoistway. When the floor hatch assembly is in the open configuration, the area of the opening provided in the floor of the elevator car covers an area of at least 0.35 m2. In consequence, the opening provided in the floor of the elevator car is large enough for providing a safety volume that fulfills the safety requirements of the applicable elevator safety code(s) such as the European elevator safety code code EN 81-20.

Exemplary embodiments of the invention further include an elevator system comprising a hoistway extending between a plurality of landings and an elevator car according to an exemplary embodiment of the invention that is arranged in the hoistway for moving between the plurality of landings.

Exemplary embodiments of the invention also include a method of accessing a space in a hoistway from an elevator car according to an exemplary embodiment of the invention that is movably arranged in said hoistway. The method includes moving the elevator car to a predefined position in the hoistway; opening the floor hatch assembly; and accessing the bottom of the hoistway via the opening that is formed in the floor of the hoistway by opening the floor hatch assembly.

In an elevator system according to an exemplary embodiment of the invention, a person may enter the hoistway conveniently from the elevator car. There is, in particular, no need for providing a manual unlocking mechanism in or at the lowest landing door for allowing the person to enter a space in a portion of the hoistway below the elevator car via the lowest landing door.

An elevator system according to an exemplary embodiment of the invention enhances the safety of a person located in the hoistway, in particular in a space below the elevator car, more particularly in a space that is located between the bottom of the elevator car and the bottom of the hoistway, by providing an opening in the floor of the elevator car that provides a safety volume that extends into the elevator car and that is large enough for preventing the person in the hoistway from being hit or squeezed by the elevator car when the elevator car is moving downwards.

In the following, a number of optional features of an elevator car, an elevator system and a method of accessing a space in the hoistway of an elevator system according to exemplary embodiments of the invention are set out. These features may be realized in particular embodiments, alone or in combination with any of the other features, unless explicitly stated otherwise.

The predefined position of the elevator car may be in the vicinity of the bottom of the hoistway in order to allow the person to access the bottom of the hoistway from the elevator car.

When the elevator car is arranged at the predefined position in the hoistway, the floor of the elevator car may be arranged not more than 1 m, in particular not more than 0.75 m, more particularly not more 0.50 m or not more than 0.25 m above the bottom of the hoistway.

Moving the elevator car to a position in which the bottom of the elevator car is arranged not more than 1 m above the bottom of the hoistway allows securely entering a space in the hoistway below the elevator car from inside the elevator car. It allows in particular entering the hoistway without using an additional tool, such as a ladder.

The opening provided in the floor of the elevator car when the floor hatch assembly is in the open configuration may a rectangular opening having lateral dimensions of at least 0.5 m times 0.7 m.

The opening may cover at least 50% of the area of the floor of the elevator car. The opening may in particular cover at least 70% of the floor of the elevator car; more particularly, the opening may cover at least 85% of the floor of the elevator car. Increasing the area of the floor of the elevator car that is covered by the opening increases the safety of a person in the hoistway below the elevator car even further.

The opening may be formed in the center of the floor. In an alternative configuration, the opening may be formed outside the center of the floor.

The floor hatch assembly may comprise at least two hatches. When arranged in their respective open configurations, the at least two hatches may provide a common opening in the floor of the elevator car. Providing the opening in the floor of the elevator car with a plurality of hatches allows reducing the size and the weight of each of the hatches. Smaller and lighter hatches may be moved more easily than large and heavy latches.

The at least two hatches may have the same size. Alternatively, the at least two hatches may differ in size.

The area of an opening that is provided in the floor of the elevator car by opening one of the hatches may be large enough for providing a safety volume that fulfills the safety requirements of the applicable elevator safety code(s).

In case two or more hatches need to be opened for providing a safety volume that fulfills the safety requirements of the applicable elevator safety code(s), the elevator car may be designed so that a person may enter the space below the elevator car only after a sufficient number of hatches has been opened for providing a safety volume that fulfills the safety requirements.

The elevator car may further comprise a floor hatch fixing mechanism that is configured for fixing the floor hatch assembly in an open position for preventing the floor hatch assembly from closing while a person is still present in the space below the elevator car.

A method according to an exemplary embodiment of the invention may include fixing the floor hatch assembly in its open position, in particular by activating a fixing mechanism.

Providing such a floor hatch fixing mechanism and fixing the floor hatch assembly in its open position may enhance the safety of the elevator system even further by preventing the floor hatch assembly from accidentally closing while the person is still present in the space below the elevator car.

The floor hatch fixing mechanism may include a mechanical fixing mechanism and/or an electrical fixing mechanism. The floor hatch fixing mechanism may in particular include an electromechanical fixing mechanism that may include a solenoid for selectively fixing and releasing the floor hatch assembly in its open position.

The floor hatch fixing mechanism may be configured such that it is releasable only from inside the elevator car, i.e. by a person located inside the elevator car, but not from outside the elevator car, i.e. by a person located outside the elevator car. The floor hatch fixing mechanism may in particular not be releasable from the hoistway. Such a configuration may prevent a person from releasing the floor hatch fixing mechanism and closing the floor hatch assembly while the person is still in the hoistway, in particular in a space below the elevator car.

An elevator system according to an exemplary embodiment of the invention may further comprise a floor hatch locking mechanism. The floor hatch locking mechanism may be configured for locking the floor hatch assembly in its closed position when the elevator car is not positioned at the predefined position in the hoistway. The floor hatch locking mechanism may further be configured for unlocking the floor hatch assembly when the elevator car is positioned at the predefined position in the hoistway.

Such a locking mechanism may enhance the safety of the elevator system by preventing the floor hatch assembly from being opened when the elevator car is not positioned at the predefined position in the hoistway. The floor hatch locking mechanism may, in particular, prevent the floor hatch assembly from being opened when the elevator car is located in an upper portion of the hoistway, in which it would be very dangerous to open the floor hatch assembly.

The floor hatch locking mechanism may comprise a locking element, such as a rod or a bolt, provided at the elevator car. The locking element may be movable between a locked position in which it locks the floor hatch assembly, and an unlocked or released position in which it does not lock the floor hatch assembly.

The floor hatch locking mechanism may further comprise an actuator, such as a roller, configured for moving the locking element from the locked position into the unlocked position when the elevator car is located at the predefined position in the hoistway. Such an actuator may allow for automatically and reliably unlocking the floor hatch locking mechanism when the elevator car is located at the predefined position in the hoistway.

Automatically unlocking the floor hatch locking mechanism facilitates the handling of the floor hatch assembly, as the floor hatch locking mechanism does not need to be operated manually. In addition, the risk of an incorrect manual operation of the floor hatch locking mechanism may be reduced or even eliminated.

The actuator may be located in the hoistway. The actuator may, for example, be mounted to a wall of the hoistway or to a guide member provided in the hoistway.

The floor hatch locking mechanism may further comprise a floor hatch lock indicator indicating whether or not the floor hatch assembly is locked by the floor hatch locking mechanism. Providing a floor hatch lock indicator may prevent a person from unsuccessfully trying to open the floor hatch assembly when it is still locked by the floor hatch locking mechanism.

The floor hatch lock indicator may include a mechanical indicator, such as a movable pointer or a movable flag, and/or an electric indicator, such as a light source, in particular an LED.

The elevator system may further comprise an elevator controller that is configured for controlling the movement of the elevator car in the hoistway. The elevator controller may be switchable between a mode of normal operation for moving passengers between the plurality of landings, and a maintenance mode that differs from the mode of normal operation. When switched into the maintenance mode, the elevator controller may be configured for positioning the elevator car at the predefined position in the hoistway. When switched into the maintenance mode, the elevator controller may in particular cause a drive system of the elevator system to move the elevator car along the hoistway until the elevator car is positioned at the predefined position in the hoistway.

The elevator controller may be switchable between the mode of normal operation and the maintenance mode by inputting specific control commands into a control panel of the elevator system, in particular into an elevator car control panel provided inside the elevator car or into one of the landing control panels provided at the landings.

Additionally or alternatively, the elevator controller may be switchable between the mode of normal operation and the maintenance mode by a separate control tool, in particular by a mobile control tool. The control tool may be configured for communication with the elevator controller via a wired data link or via a wireless data link.

The elevator car may comprise a floor hatch motor, in particular an electric floor hatch motor, for moving at least one hatch of the floor hatch assembly between a closed position and an open position. Moving at least one hatch by a floor hatch motor may be convenient for the person aiming for access to a space in the hoistway below the elevator car.

Additionally or alternatively, at least one hatch of the floor hatch assembly may comprise at least one handle for allowing the person to move the hatch manually between the closed position and the open position. Moving a hatch manually is very reliable. It further allows for reducing the weight and the costs of the elevator car by not adding a floor hatch motor to the elevator car.

The elevator system may comprise a plurality of landing doors provided at the plurality of landings. The plurality of landing doors may include a lowest landing door provided at the lowest landing and other landing doors provided at other landings above the lowest landing.

At least some of the other landing doors, i.e. some of the landing doors that are not located at the lowest landing, may comprise a manual unlocking mechanism that allows for manually unlocking the respective landing door from the respective landing in order to provide access to the hoistway from the respective landing. Landing doors comprising such manual unlocking mechanisms may be beneficial for inspection, maintenance and/or repair of the elevator system, and/or for rescuing passengers from the elevator car in case of a malfunction of the elevator system.

The lowest landing door may, however, be formed without a manual unlocking mechanism so that a space located at the bottom of the hoistway is accessible not from the lowest landing, but only from inside the elevator car via the floor hatch fixing mechanism, as it has been described before. Such a configuration may allow for preventing persons, in particular mechanics, from entering a space located at the bottom of the hoistway, in particular a space below the elevator car, via the lowest landing door.

The features, modifications and effects that have been described with respect to an elevator car and an elevator system according to exemplary embodiments of the invention analogously apply to a method of accessing a space in the hoistway of an elevator system according to an exemplary embodiment of the invention.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIGS. 2A to 2D schematically illustrate a method of accessing a space in the hoistway of an elevator system according to an exemplary embodiment of the invention.

FIGS. 3A and 3B schematically depict a floor hatch locking mechanism of an elevator system according to an exemplary embodiment of the invention.

FIG. 4 depicts a schematic side view of the floor of an elevator car according to an exemplary embodiment of the invention.

FIG. 5 depicts an exemplary embodiment of a floor hatch locking mechanism for locking a floor hatch assembly in its closed position.

FIG. 6 depicts a person opening the floor hatch assembly of an elevator car according to an exemplary embodiment of the invention.

FIGS. 7A and 7B schematically show the person in a space below the elevator car.

FIG. 8 depicts an exemplary embodiment of a floor hatch fixing mechanism that allows fixing a hatch of a floor hatch fixing assembly in its vertical open position.

FIG. 9 depicts a schematic perspective view of a portion of the floor of the elevator car of an elevator system according to an exemplary embodiment of the invention.

### DETAILED DESCRIPTION OF THE INVENTION

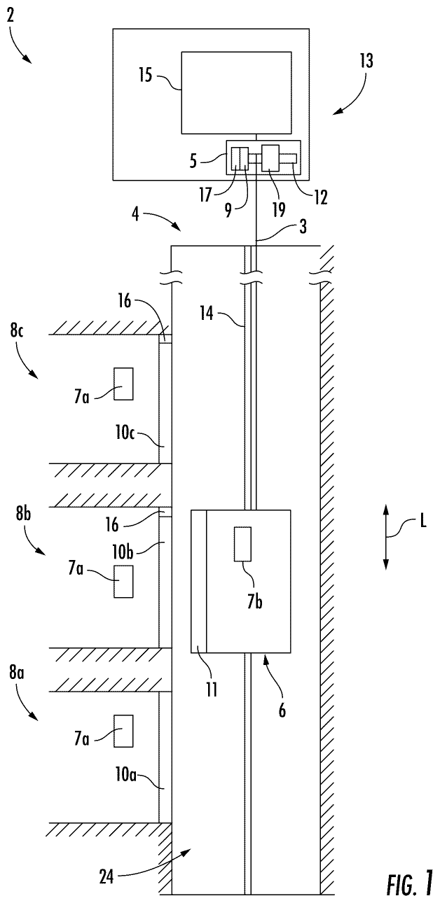

FIG. 1 schematically depicts an elevator system 2 according to an exemplary embodiment of the invention.

The elevator system 2 comprises a hoistway 4 extending in a longitudinal direction L between a plurality of landings 8a-8c located on different floors. The elevator system 2 includes an elevator car 6 arranged in the hoistway 4 for being moved along the longitudinal direction L between the plurality of landings 8a-8c. The elevator car 6 may in particular be movable along at least one elevator car guide member 14, such as at least one elevator car guide member, provided in the hoistway 4 and extending along the longitudinal direction L.

The longitudinal direction L may be oriented in a vertical direction, as it is depicted in FIG. 1. In an alternative embodiment not depicted in the figures the longitudinal direction L may be inclined with respect to the vertical direction.

Although only a single elevator car guide member 14 is visible in FIG. 1, the elevator system 2 may comprise a plurality of elevator car guide members 14.

Although only a single elevator car 6 is depicted in FIG. 1, exemplary embodiments of the invention may include elevator systems 2 comprising a plurality of elevator cars 6 moving in one or more hoistways 4.

The elevator car 6 is movably suspended by means of a tension member 3.

The tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the tension member 3, which is coupled to the shaft 12, in order to move the elevator car 6 in the hoistway 4 along the longitudinal direction L between the plurality of landings 8a-8c.

The elevator drive system 5 is further provided with at least one elevator brake 19 for braking rotation of the shaft 12 in order to allow for stopping movement of the elevator car 6.

The elevator system 2 may further include an elevator counterweight, which is not depicted in FIG. 1. The elevator counterweight may be attached to the tension member 3 opposite to the elevator car 6 and configured for moving concurrently and in opposite direction with respect to the elevator car 6 along at least one elevator counterweight guide member, which is also not shown in FIG. 1.

Exemplary embodiments of the invention may be employed in elevator systems 2 comprising a counterweight and in elevator systems 2 that do not comprise an elevator counterweight.

The tension member 3 may be a rope, e.g. a steel cord, or a belt, in particular a coated steel belt. The tension member 3 may be uncoated. Alternatively, the tension member 3 may be coated with a coating, e.g. with a coating having the form of a polymer jacket. In a particular embodiment, the tension member 3 may be a belt comprising a plurality polymer coated steel cords (not shown). The elevator system 2 may have a traction drive including a traction sheave for driving the tension member 3.

The exemplary embodiment shown in FIG. 1 uses a 1:1 roping for suspending the elevator car 6. The skilled person easily understands that the type of the roping is not essential for the invention and that different kinds of roping, e.g. a 2:1 roping or a 4:1 roping may be used as well.

A landing door 10a-10c is provided at each of the landings 8a-8c, respectively.

At least some of the landing doors 10a-10c, in particular landing doors 10b, 10c that are not located at the lowest landing 8a, may comprise a manual unlocking mechanism 16 that allows for manually unlocking the respective landing door 10b, 10c from the respective landing 8b, 8c for providing access to the hoistway 4 from the respective landing 8b-8c. Landing doors 10b, 10c comprising such manual unlocking mechanisms 16 may be beneficial for inspection, maintenance and/or repair of the elevator system 2, and/or for rescuing passengers from the elevator car 6 in case of a malfunction of the elevator system 2.

The landing door 10a at the lowest landing 8a may, however, be formed without a manual unlocking mechanism 16 so that a space 24 located at a bottom 4a of the hoistway 4 is accessible not from the lowest landing 8a, but only from inside the elevator car 6. Such a configuration may allow for preventing persons 20 from entering a space 24 located at the bottom 4a of the hoistway 4, in particular a space 24 below the elevator car 6, via the landing door 10a at the lowest landing 8a.

The elevator car 6 is provided with an elevator car door 11 for allowing passengers to transfer between a landing 8a-8c and the interior of the elevator car 6, when the elevator car 6 is positioned at the respective landing 8a-8c.

For moving the elevator car 6 along the hoistway 4 between the different landings 8a-8c, the elevator drive system 5 may be controlled by an elevator controller 15 of the elevator system 2.

The elevator system 2 may comprise a machine room 13 housing the elevator drive system 5 and the elevator controller 15. Alternatively, the elevator system 2 may be a machine room-less elevator system 2.

Input to the elevator controller 15 may be provided via landing control panels 7a provided on every landing 8a-8c, in particular in the vicinity of the landing doors 10a-10c, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled to the elevator controller 15 by means of electrical wiring not shown in FIG. 1, in particular by an electric bus, or by wireless data connections.

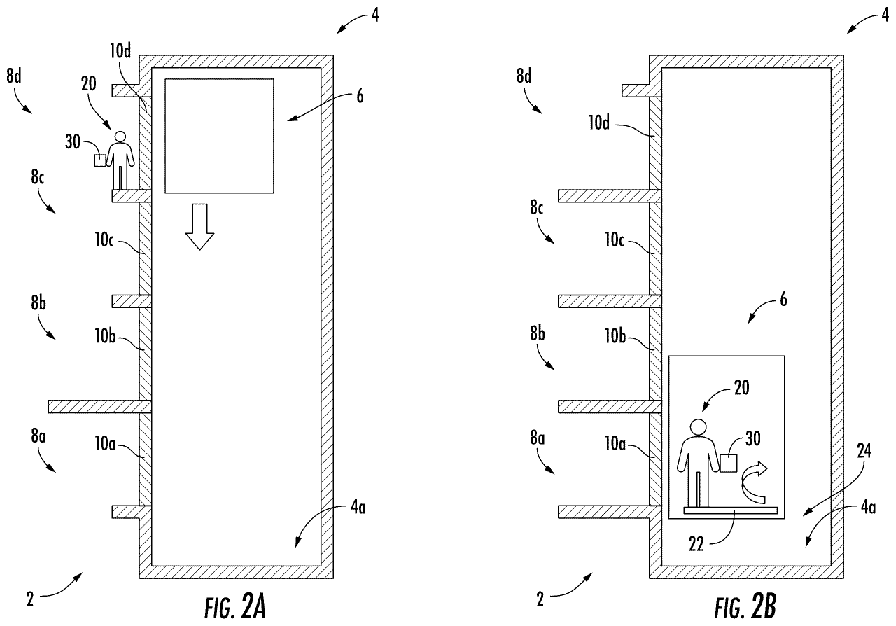

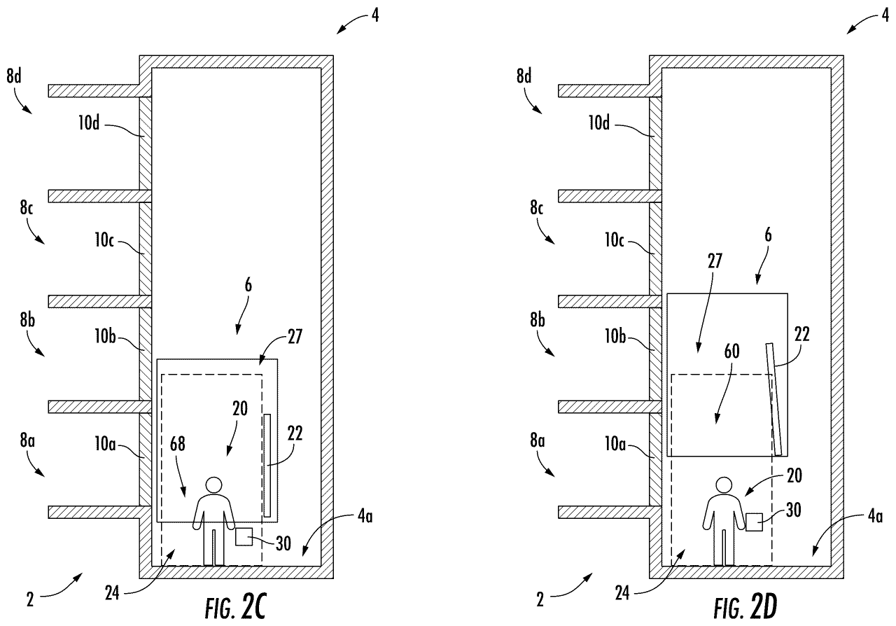

FIGS. 2A to 2D schematically illustrate a method of accessing a space 24 located in the hoistway 4 of the elevator system 2 below the elevator car 6, in particular a space 24 located at the bottom 4a of the hoistway 4, according to an exemplary embodiment of the invention.

In FIG. 2A, a person 20, in particular a mechanic, is present at one of the landings 8a-8d and requests the elevator controller 15 to move the elevator car 6 to said landing 8d. Although in FIG. 2A the person 20 is shown at the uppermost landing 8d, the person 20 may be located at any landing 8a-8d of the elevator system 2.

After the elevator car 6 has arrived at the landing 8d at which the person 20 is located, the person 20 enters the elevator car 6 through the landing door 10d.

The person 20 may enter the elevator car 6 like a normal passenger. The person 20 does in particular not need any specific tools or keys for entering the elevator car 6.

After the person 20 has entered the elevator car 6, the person 20 instructs the elevator controller 15 to move the elevator car 6 to a predefined position in the hoistway 4 of the elevator system 2, in particular to a predefined position that allows the person 20 to access and/or enter the space 24 at the bottom 4a of the hoistway 4 from the bottom of the elevator car 6.

The person 20 may in particular switch the elevator controller 15 from a mode of normal operation that is configured for moving passengers between the different landings 8a-8d into a maintenance mode.

The person 20 may supply instruction to the elevator controller 15 by entering commands via the elevator car control panel 7b and/or via a specific mobile control tool 30 that is configured for communicating with the elevator controller 15.

The mobile control tool 30 may communicate with the elevator controller 15 via a wired data connection (not shown) or via a wireless data connection.

In FIG. 2B the elevator car 6 has reached the predefined position in the hoistway 4 and stopped at said predefined position.

The predefined position of the elevator car 6 may be a position at one of the landings 8a-8d, in particular a position at the lowest landing 8a as it is depicted in FIG. 2B. Alternatively, the predefined position may be a position between two adjacent landings 8a-8d or a position below the lowest landing 8a.

After the elevator car 6 has reached the predefined position in the hoistway 4, the person 20 opens a floor hatch assembly 22 that is formed in the floor 6a of the elevator car 6. Before opening the floor hatch assembly 22, the person 20 may unlock the floor hatch assembly 22, if necessary.

The person 20 may then enter into a space 24 below the elevator car 6, in particular a space 24 that is formed between the bottom of the elevator car 6 and the bottom 4a of the hoistway 4 via an opening 60 that is formed in the floor 6a of the elevator car 6 opening the floor hatch assembly 22, as it is depicted in FIG. 2C.

The opening 60 formed in the floor 6a of the elevator car 6 allows a safety volume 27 that is large enough to fulfill the safety requirements of the applicable elevator safety code to extend from the bottom 4a of the hoistway 4 into the elevator car 6.

The elevator car 6 may move along the hoistway 4, as depicted in FIG. 2D, without risking injuring the person 20 in the space 24 at the bottom of the hoistway 4.

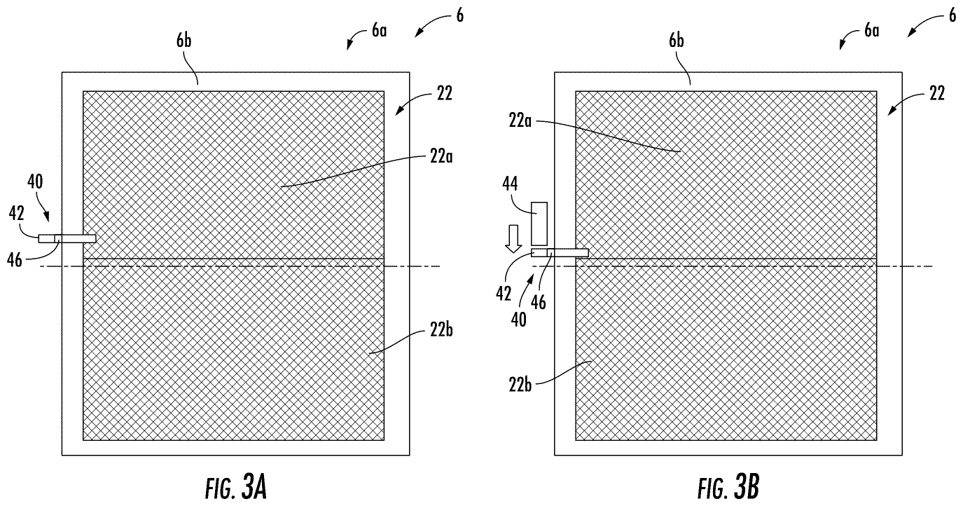

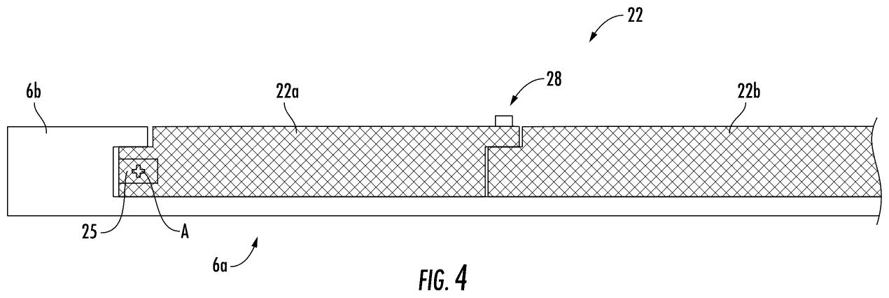

FIGS. 3A and 3B depict schematic plain views of the floor 6a of an elevator car 6 according to the present invention.

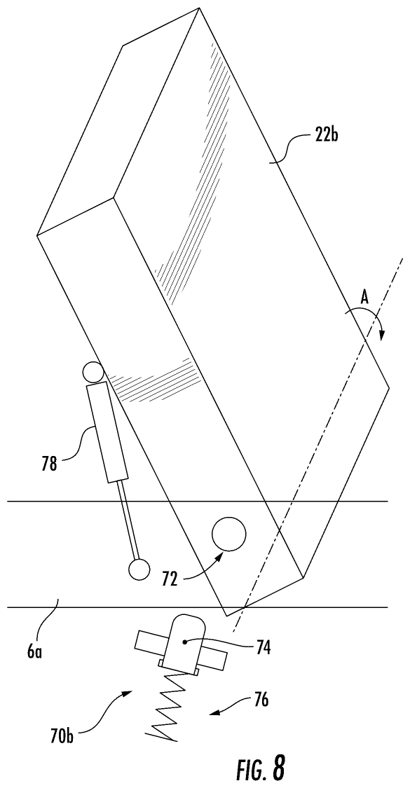

The floor 6a of the elevator car 6 comprises a floor hatch assembly 22 including a first hatch 22a and a second hatch 22b. The first hatch 22a and the second hatch 22b are movable with respect to a frame 6b of the elevator car 6 between a closed configuration depicted in FIGS. 3A and 3B and an open configuration that is depicted in FIGS. 7A and 7B.

When arranged in the open configuration, the floor hatch assembly 22 provides an opening 60 in the floor 6a of the elevator car 6 that allows accessing the space 24 below the elevator car 6, as it has been discussed and shown before with reference to FIGS. 2A to 2D.

The first hatch 22a and the second hatch 22b may be of equal size. Alternatively, they may have different sizes.

In the exemplary embodiment depicted in the figures, the floor hatch assembly 22 is provided as a trap door assembly comprising two hatches 22a, 22b that are pivotable around an axis A. In an alternative embodiment that is not explicitly shown in the figures, the floor hatch assembly 22 may comprise only single hatch 22a, 22b or more that two hatches 22a, 22b.

The floor hatch assembly 22 being provided as a trap door is only an exemplary configuration. In alternative embodiments that are not explicitly depicted in the figures the floor hatch assembly 22 may have an alternative configuration. The floor hatch assembly 22 may, for example, include at least one sliding door that is linearly movable between a closed position and an open position. In a further embodiment, the floor hatch assembly 22 may include an opening 60 formed in the floor 6a of the elevator car 6 and at least one cover that may be positioned in and/or above the opening 60 for closing and/or covering the opening 60. The at least one cover may be removed from the opening 60 for providing access to the space 24 below the elevator car 6 via the opening 60.

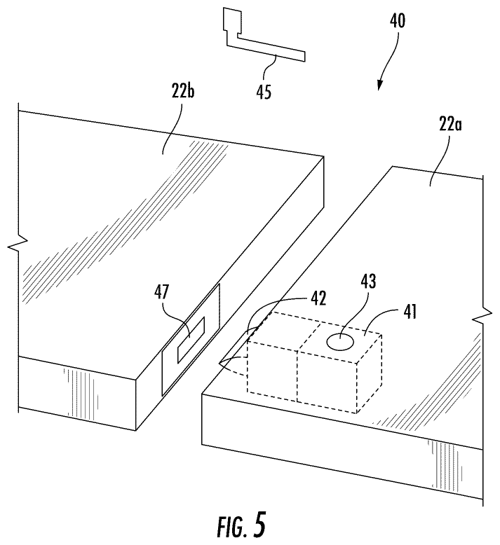

FIG. 4 depicts a schematic side view of the floor 6a of the elevator car 6 showing the floor hatch assembly 22 including the two hatches 22a, 22b. The two hatches 22a, 22b partially overlap each other. In consequence, the second hatch 22b is movable only after the first hatch 22a has been moved from the closed position depicted in FIG. 4 into an open position, in which it does not overlap with the second hatch 22b.

At least one of the hatches 22a, 22b may be equipped with at least one handle 28 in order to allow for moving the at least one hatch 22a, 22b manually between the closed position and the open position.

Alternatively or additionally, the elevator car 6 may be equipped with at least one floor hatch motor 25 that is configured for moving at least one of the hatches 22a, 22b between the closed position and the open position.

The elevator car 6 may further comprise a floor hatch locking mechanism 40. A floor hatch locking mechanism 40 is schematically depicted in FIGS. 3A and 3B.

The floor hatch locking mechanism 40 may be configured for looking the floor hatch assembly 22 in the closed position when the elevator car 6 is not positioned at the predefined position in the hoistway 4. The floor hatch locking mechanism 40 may further be configured for unlocking the floor hatch assembly 22 in order to allow for opening the floor hatch assembly 22 when the elevator car 6 is positioned at the predefined position in the hoistway 4.

In the exemplary embodiment depicted in FIGS. 3A and 3B, the floor hatch locking mechanism 40 comprises a floor hatch locking element 42, for example a rod or bolt, that is movable between a locked position in which it blocks movement of the first hatch 22a and an unlocked position in which it does not block movement of the first hatch 22a.

The locked position of the floor hatch locking element 42 is schematically depicted in FIG. 3A, and the unlocked position of the floor hatch locking element 42 is schematically depicted in FIG. 3B.

The floor hatch locking mechanism 40 may further comprise an actuator 44, for example a roller, that is provided at a predetermined position in the hoistway 4 and configured for moving, in particular urging, the locking element 42 from the locked position into the unlocked position when the elevator car 6 is located at the predefined position in the hoistway 4.

In an elevator system 2 comprising a floor hatch locking mechanism 40, persons 20 are reliably prevented from opening the floor hatch assembly 22 when the elevator car 6 is not positioned at the predefined position in the hoistway 4. As a result, providing a floor hatch locking mechanism 40 may enhance the safety of the elevator system 2 even further.

Optionally, the floor hatch locking mechanism 40 may comprise a floor hatch lock indicator 46 that is configured for indicating whether or not the floor hatch assembly 22 is locked by the floor hatch locking mechanism 40.

A floor hatch lock indicator 46 may prevent a person 20 from unsuccessfully trying to open the floor hatch assembly 22 when it is locked by the floor hatch locking mechanism 40.

The floor hatch lock indicator 46 may include a mechanical indicator, such as a movable pointer or a movable flag, indicating the position of the locking element 42. The floor hatch lock indicator 46 may also include an electric indicator, in particular a light source, such as an LED.

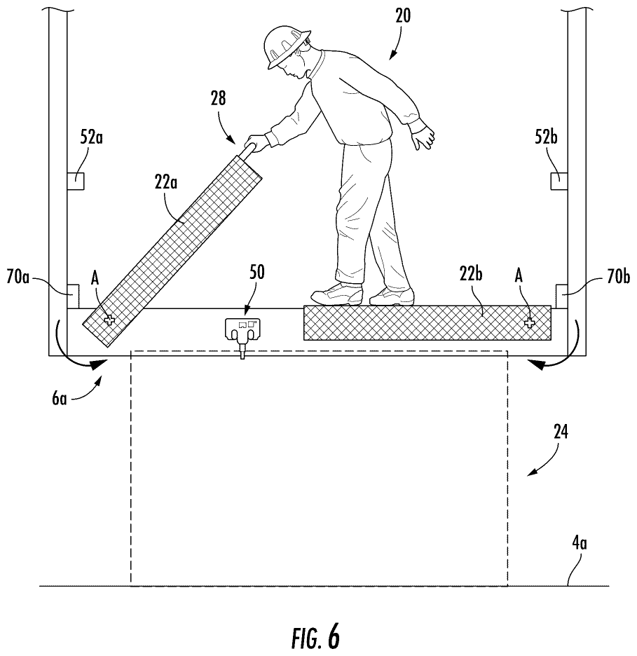

FIG. 5 depicts an alternative floor hatch locking mechanism 40 that may be unlocked manually by a person 20 using a handle or key 45, in particular a triangular key 45.

The floor hatch locking mechanism 40 depicted in FIG. 5 comprises a sliding lock 41 that is employed for securing the first floor hatch 22a in the closed position. The floor hatch locking mechanism 40 includes a floor hatch locking element 42 having the form of a latch that is operable using the handle or key 45.

When the lock is engaged, the floor hatch locking element 42 extends into a corresponding strike plate 47 formed in the frame 6b of the elevator car 6, preventing the first floor hatch 22a from being opened.

The floor hatch locking mechanism 40 comprises a mechanism that allows for moving the floor hatch locking element 42. When the handle or key 45 is inserted into a corresponding opening 43 in the sliding lock 41 and turned, it triggers the sliding lock 41 to either extend the floor hatch locking element 42 into the strike plate 47 for securing the first floor hatch 22a in the closed position, or to retract the floor hatch locking element 42 from the strike plate 47 in order to allow the first floor hatch 22a to open.

Optionally, the floor hatch locking mechanism 40 may comprise an elastic element (not shown), such as a spring, that is configured for urging the floor hatch locking element 42 into the strike plate 47.

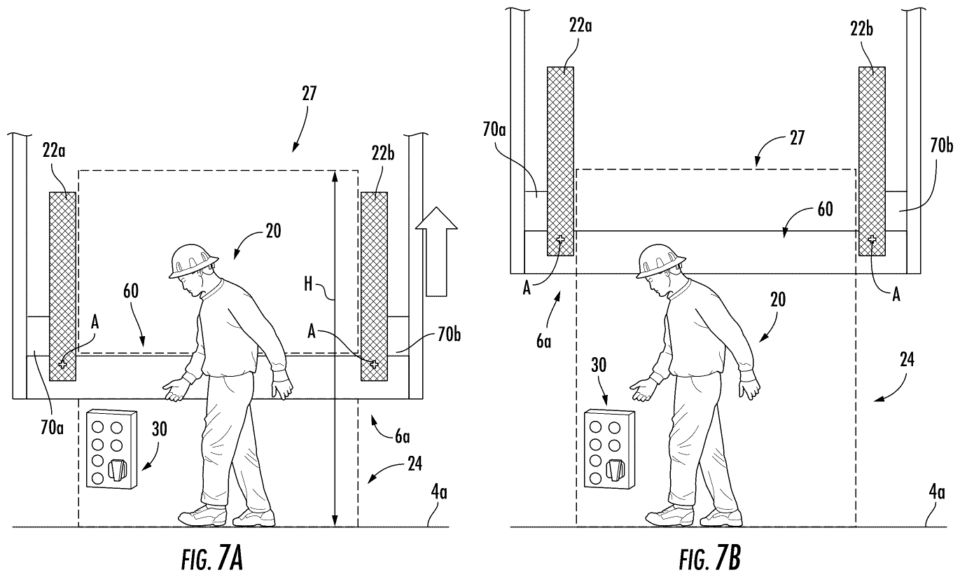

FIG. 6 schematically shows a person 20, in particular a mechanic, opening the first hatch 22a. In a following step that is not explicitly depicted in the figures, the person 20 may open the second hatch 22b as well.

Optionally, the elevator car 6 may comprise an electric safety switch 50 that is configured for detecting movement of the first hatch 22a and for interrupting the supply of electric power to the motor 9 of the elevator drive system 5 as soon as the first hatch 22a is moved out of its completely closed position. Interrupting the supply of electric power to the motor 9 of the elevator drive system 5 may add additional safety to the elevator system 2 by preventing the elevator car 6 from being moved by the elevator drive system 5 while the floor hatch 22 is open and allows a person 20 to enter the space 24 below the elevator car 6.

Activating the electric safety switch 50 may also activate the at least one elevator brake 19 and/or at least one elevator safety device (not shown) for preventing any movement of the elevator car 6.

Optionally, the elevator car 6 may comprise at least one additional electric safety switch 52a, 52b configured for detecting the position of at least one of the hatches 22a, 22b and for allowing the elevator car 6 to move after a sufficient number of hatches 22a, 22b has been opened for providing a safety volume 27 that fulfills the safety requirements of the applicable elevator safety code(s).

FIGS. 7A and 7B schematically show the person 20 in the space 24 below the elevator car 6. The person 20 has entered the space 24 below the elevator car 6 via the opening 60 that has been formed in the floor 6a of the elevator car 6 by opening the first and second hatches 22a, 22b.

Optionally, the person 20 may use a ladder (not shown) for entering the space 24 below the elevator car 6. The elevator car 6 may, however, be positioned at a position in the hoistway 4 that is sufficiently low for allowing the person 20 to enter the space 24 below the elevator car 6 from the elevator car 6 without using a ladder.

As depicted in FIGS. 7A and 7B, the opening 60 that is formed in the floor 6a of the elevator car 6 by opening the floor hatch assembly 22 provides a safety volume 27 above the bottom 4a of the hoistway 4 that prevents any person 20 located in the space 24 below the elevator car 6 from being hit or squeezed by the elevator car 6, in particular when the elevator car 6 is moving downwards.

When the floor hatch assembly 22 is open and provides a sufficiently large safety space 27 extending into the elevator car 6, the person 20 in the space 24 below the elevator car 6 may move the elevator car 6 up and down along the hoistway 4 without bearing the risk of being hit or squeezed by the elevator car 6.

In order to allow the person 20 to move the elevator car 6, a control tool 30 that is configured for supplying control commands to the elevator controller 15 may be provided in the space 24 below the elevator car 6. Alternatively, the person 20 may use a mobile control tool 30 for supplying control commands to the elevator controller 15 in order to move the elevator car 6.

The control tool 30 may be configured to bypass the electric safety switch 50 in order to allow moving the elevator car 6 in the hoistway 4 when the floor hatch assembly 22 is open.

The safety volume 27 provided by the opening 60 in the floor 6a of the elevator car 6 may be large enough for fulfilling the safety requirements of the respectively applicable elevator safety code(s).

In order to fulfill typical elevator safety code(s), the safety volume 27 may have a height H of at least 2 m and cover an area of at least 0.35 m2. The opening 60 may in particular be rectangular and have lateral dimensions of at least 0.5 m times 0.7 m.

The opening 60 formed in the floor 6a of the elevator car 6 may cover at least 50% of the area of the floor 6a of the elevator car 6. The opening 60 may in particular cover at least 70% of the floor 6a of the elevator car 6; more particularly the opening 60 may cover at least 85% of the floor 6a of the elevator car 6.

The opening 60 may be formed in the center of the floor 6a of the elevator car 6. Alternatively, the opening 60 may be formed at a position that is offset from the center of the floor 6a.

The exemplary embodiment of the elevator car 6 may further comprise first and second floor hatch fixing mechanisms 70a, 70b. The first and second floor hatch fixing mechanisms 70a, 70b may be configured for fixing the hatches 22a, 22b of the floor hatch assembly 22 in their respective open positions for preventing the floor hatch assembly 22 from accidentally closing while a person 20 is present in the space 24 below the elevator car 6.

The floor hatch fixing mechanisms 70a, 70b may be coupled with the elevator controller 15 and the elevator controller 15 may be configured to allow moving the elevator car 6 along the hoistway 4 only if all hatches 22a, 22b of the floor hatch assembly 22 are fixed in their respective open positions by the corresponding floor hatch fixing mechanisms 70a, 70b.

The first and second floor hatch fixing mechanisms 70a, 70b may in particular be configured such as to be releasable only from inside the elevator car 6 but not from outside the elevator car 6, in particular not from the space 24 below the elevator car 6. Such floor hatch fixing mechanisms 70a, 70b may enhance the safety of the elevator system 2 even further, as they may be released by a person 20 only after the person 20 has left the space 24 below the elevator car 6 and returned into the elevator car 6.

Each floor hatch fixing mechanism 70a, 70b may comprise a lever, a button or a switch provided in the elevator car 6 for releasing the floor hatch fixing mechanism 70a, 70b in order to allow the hatches 22a, 22b to move from their open positions into their closed positions.

The first and second floor hatch fixing mechanisms 70a, 70b may be purely mechanical floor hatch fixing mechanisms 70a, 70b comprising only mechanical components, such as levers, springs and/or catches for mechanically fixing the floor hatches 22a, 22b in their respective open positions.

Alternatively, at least one of the first and second floor hatch fixing mechanisms 70a, 70b may comprise electric components in addition to mechanical components, in particular electromagnetic components, such as a solenoid, for selectively fixing the respective hatch 22a, 22b in its open position.

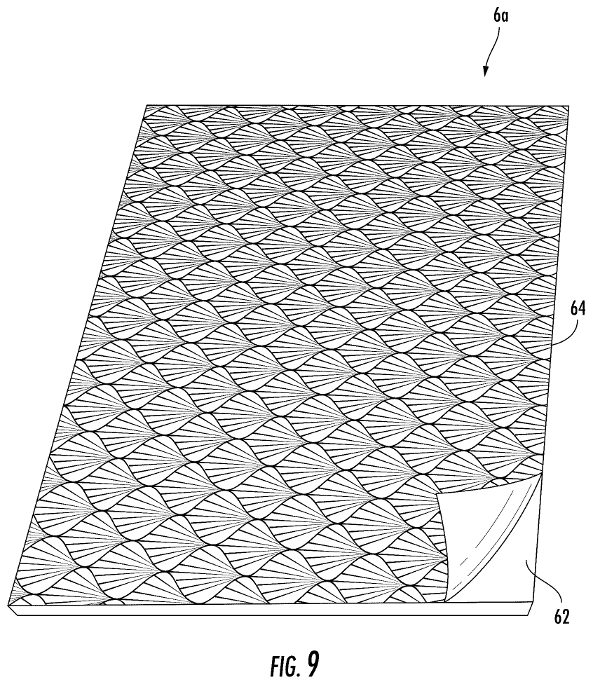

FIG. 8 depicts an exemplary embodiment of a floor hatch fixing mechanism 70b that allows fixing the second hatch 22b of a floor hatch assembly 20 in an open position.

In the exemplary embodiment of the floor hatch fixing mechanism 70b depicted in FIG. 8, an opening or hole 72 is formed in a lateral surface of the second hatch 22a.

The floor hatch fixing mechanism 70b further comprises a locking pin 74 and an elastic element 76, such as a spring.

The elastic element 76 urges the locking pin 74 into the opening or hole 72 for fixing the second hatch 22b in the open position, preventing the second hatch 22b from rotating out of the open position once into the closed position.

Optionally, the elevator car 6 may further be equipped with a braking jack 78 for damping and smoothening the movement of the second hatch 22b.

The configuration shown for the second hatch 22b in FIG. 8 may be similarly applied to the first hatch 22a of the floor hatch assembly 22.

FIG. 9 shows a schematic perspective view of a portion of the floor 6a of the elevator car 6.

In the embodiment depicted in FIG. 9 the floor 6a of the elevator car 6 comprises a solid floor panel 62 that may, for example, be made of metal or a material comprising metal. The floor hatch assembly 22 is formed in said floor panel 62. The floor panel 62 is covered by a cover 64, such as a carpet, hiding the floor hatch assembly 22 from the passengers of the elevator system 2.

In an embodiment, the cover 64 may be provided with a magnetic coating and/or a number of magnetic elements.

The magnetic coating and/or the magnetic elements may in particular be provided on the side of the cover 64 facing the floor panel 62 for removably fixing the cover 64 to the floor panel 62. Fixing the carpet to the floor panel 62 using a magnetic coating and/or magnetic elements allows the person 20 to easily and conveniently remove the cover 64 from the floor panel 62 for accessing and opening the floor hatch assembly 22 and entering the space 24 below the elevator car 6.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the dependent claims.

What is claimed is:

1. Elevator car (6) configured for moving in a hoistway (4) between a plurality of landings (8a-8d), the elevator car (6) comprising a floor (6a) provided at a bottom of the elevator car (6) and at least one floor hatch assembly (22) formed in the floor (6a) of the elevator car (6);
wherein the at least one floor hatch assembly (22) is movable between a closed configuration and an open configuration;
wherein the at least one floor hatch assembly (22), when arranged in the open configuration, provides an opening (60) in the floor (6a) of the elevator car (6) that allows a person (20) to access a space (24) in the hoistway (4) below the elevator car (6) from inside the elevator car (6); and
wherein, when the floor hatch assembly (22) is in the open configuration, the area of the opening (60) provided in the floor (6a) of the elevator car (6) covers an area of at least 0.35 m2.

2. Elevator car (6) according to claim 1, wherein the opening (60) is in particular rectangular and has dimensions of at least 0.5 m times 0.7 m.

3. Elevator car (6) according to claim 1, wherein, when the floor hatch assembly (22) is in the open configuration, the opening (60) covers at least 50% of the area of the floor (6a) of the elevator car (6); in particular at least 70% of the area of the floor (6a) of the elevator car (6); wherein the opening (60) covers more particularly at least 85% of the area of the floor (6a) of the elevator car (6).

4. Elevator car (6) according to claim 1, wherein the floor hatch assembly (22) comprises at least two hatches (22a, 22b), wherein the at least two hatches (22a, 22b) have in particular the same size.

5. Elevator car (6) according to claim 4, wherein the at least two hatches (22a, 22b), when arranged in their respective open configurations, provide a common opening (60) in the floor (6a) of the elevator car (6).

6. Elevator car (6) according to claim 1, further comprising at least one floor hatch assembly fixing mechanism (70a, 70b) for fixing the at least one floor hatch assembly (22) in the open configuration.

7. Elevator car (6) according to claim 6, wherein the at least one floor hatch assembly fixing mechanism (70a, 70b) is releasable only from inside the elevator car (6).

8. Elevator car (6) according to claim 1,
wherein the at least one floor hatch assembly (22) comprises at least one handle (28) that allows moving the at least one floor hatch assembly (22) manually between its closed configuration and its open configuration; and/or
wherein the elevator car (6) comprises a floor hatch motor (25) for moving the at least one floor hatch assembly (22) between its closed configuration and its open configuration.

9. Elevator system (2) comprising a hoistway (4) extending between a plurality of landings (8a-8d), and at least one elevator car (6) according to claim 1 that is movable in the hoistway (4).

10. Elevator system (2) according to claim 9 comprising:
at least one floor hatch locking mechanism (40) for locking the at least one floor hatch assembly (22) in a closed configuration when the elevator car (6) is not positioned at a predefined position in the hoistway (4), and for unlocking the at least one floor hatch assembly (22) when the elevator car (6) is positioned at the predefined position in the hoistway (4);
wherein the floor hatch locking mechanism (40) comprises in particular:
a locking element (42) provided at the elevator car (6), the locking element (42) being movable between a locked configuration in which it locks the at least one floor hatch assembly (22), and an unlocked configuration in which it does not lock the at least one floor hatch assembly (22); and
a actuating element (44), such as a roller, provided in the hoistway (4) and configured for moving the locking element (42) from the locked configuration into the unlocked configuration when the elevator car (6) is located at the predefined position.

11. Elevator system (2) according to claim 10 comprising a door lock indicator (46) indicating whether the floor hatch assembly (22) is locked by the floor hatch locking mechanism (40).

12. Elevator system (2) according to claim 9, further comprising
an elevator controller (15) for controlling the movement of the elevator car (6) in the hoistway (4), wherein the elevator controller (15) is switchable into a maintenance mode that differs from the mode of normal operation and in which the elevator controller (15) is configured for positioning the elevator car (6) at the predefined position in the hoistway (4); and/or
a control tool (30) comprising at least one control element that allows manually controlling the movement of the elevator car (6) in the hoistway (4), wherein the control tool (30) is a mobile control tool (30) or wherein the control tool (30) is arranged adjacent to the bottom (4a) of the hoistway (4).

13. Elevator system (2) according to claim 9, comprising a plurality of landing doors (10a-10d) provided at the plurality of landings (8a-8d), including a lowest landing door (10a) provided at the lowest landing (8a), wherein the lowest landing door (10a) does not comprise a manual unlocking mechanism (16) that would allow manually unlocking the lowest landing door (10a) from the lowest landing (8a).

14. Method of accessing a space (24) in a hoistway (4) below the elevator car (6) from an elevator car (6) according to claim 1; wherein the method includes:
moving the elevator car (6) to a predefined position in the hoistway (4);
opening a floor hatch assembly (22) provided in the floor (6a) of the elevator car (6); and
accessing the bottom (4a) of the hoistway (4) via the opening (60) that is formed in the floor (6a) of the hoistway (4) by opening (60) the floor hatch assembly (22).

15. Method according to claim 14, wherein the method further includes fixing the at least one floor hatch assembly (22) in its open configuration, in particular by activating a fixing mechanism that is releasable only from inside the elevator car (6).
